(19) United States
(12) Patent Application Publication
(10) Pub. No.: US 2014/0150587 A1
(43) Pub. Date: Jun. 5, 2014

(54) TRANSFER

(71) Applicants: Isao KOZAWA, Toyota-shi (JP); Hideki TAMOTO, Toyota-shi (JP)

(72) Inventors: Isao KOZAWA, Toyota-shi (JP); Hideki TAMOTO, Toyota-shi (JP)

(73) Assignee: TOYOTA JIDOSHA KABUSHIKI KAISHA, Toyota-shi (JP)

(21) Appl. No.: 14/095,002

(22) Filed: Dec. 3, 2013

(30) Foreign Application Priority Data
Dec. 5, 2012 (JP) 2012-266458

(51) Int. Cl. F16H 1/02

(52) U.S. Cl. CPC F16H 1/02
USPC 74/421 A

(57) ABSTRACT

A transfer includes an input gear, an intermediate gear, an output gear, and an electric motor. Driving torque is transmitted to the input gear. The intermediate gear engages with the input gear. The output gear engages with the intermediate gear. The electric motor is connected to the intermediate gear. A diameter of the intermediate gear is smaller than a diameter of the input gear and a diameter of the output gear.

### INCORPORATION BY REFERENCE

The disclosure of Japanese Patent Application No. 2012-266458 filed on Dec. 5, 2012 including the specification, drawings and abstract is incorporated herein by reference in its entirety.

### BACKGROUND OF THE INVENTION

1. Field of the Invention

The present invention relates to a transfer, particularly to a transfer provided with an electric motor.

2. Description of Related Art

A transfer provided with an electric motor has been known (see Japanese Patent Application Publication No. 2004-249987 (JP 2004-249987 A), for example).

JP 2004-249987 A discloses a power divider including a drive shaft to which driving torque is input, a rear wheel output shaft and a front wheel output shaft to which the driving torque is transmitted, and a clutch device that divides the driving torque for the output shafts.

A first gear (input gear), an idle gear (intermediate gear), and a second gear (output gear) are arranged between the clutch device and the front wheel output shaft, and the driving torque is transmitted in this order. Further, the idle gear is formed to have a larger diameter than the first gear and the second gear. The idle gear is formed in a hollow shape, and an electric motor for actuating the clutch device is provided (assembled) inside the idle gear.

A drive conversion device that converts rotational movement caused by the electric motor into prescribed driving force for the clutch device is arranged between the electric motor and the clutch device. Accordingly, the rotational movement caused by the electric motor is transmitted to the clutch device via the drive conversion device.

### SUMMARY OF THE INVENTION

In the power divider disclosed in JP 2004-249987 A, the idle gear (intermediate gear) is formed to have a larger diameter than the first gear (input gear) and the second gear (output gear), and the outer diameter of the intermediate gear thus becomes large. In addition, because the motor is provided (assembled) inside the idle gear (intermediate gear), the outer diameter of the idle gear (intermediate gear) becomes further larger. Accordingly, the size of a periphery of a portion where the intermediate gear is arranged in the transfer becomes large, thus resulting in impaired installability in a vehicle.

The present invention provides a transfer that can improve the installability in a vehicle.

A transfer in accordance with an aspect of the present invention includes: an input gear to which driving torque is transmitted; an intermediate gear engaging with the input gear; an output gear engaging with the intermediate gear; and an electric motor connected to the intermediate gear. A diameter of the intermediate gear is smaller than a diameter of the input gear and a diameter of the output gear.

According to the transfer having such a configuration, because the diameter of the intermediate gear is smaller than the diameters of the input gear and the output gears that engage with the intermediate gear, a periphery of a portion (intermediate portion) in which the intermediate gear is arranged in the transfer can be made smaller in size. In addition, in the present invention, the intermediate portion of the transfer can further be made small in size compared to a case where the electric motor is provided (assembled) inside the intermediate gear. Accordingly, installability of the transfer in the vehicle can be improved.

In the transfer, the number of teeth of the intermediate gear may be less than the number of teeth of the input gear and the number of teeth of the output gear. In such a configuration, the speed of rotation caused by the electric motor is reduced and transmitted to the input gear and the output gear that engage with the intermediate gear.

In the transfer, the electric motor may be arranged outside of the intermediate gear in an axial direction of the electric motor, the intermediate gear may have an inner peripheral portion, and an inner diameter of the inner peripheral portion may be smaller than an outer diameter of the electric motor. In such a configuration, a bearing that supports the intermediate gear can be made small in size compared to a case where the diameter of the inner peripheral portion of the intermediate gear is larger than the outer diameter of the electric motor.

In the transfer, the intermediate gear may have an inner peripheral portion, a first fitting portion may be provided in the inner peripheral portion, and a second fitting portion fitting in the first fitting portion may be provided in an outer peripheral portion of a shaft of the electric motor. In such a configuration, the first fitting portion of the intermediate gear and the second fitting portion of a shaft portion of the electric motor are fitted together, thereby facilitating direct coupling. Further, because the intermediate gear and the shaft portion of the electric motor are directly coupled together and thereby allowed to function as a speed reduction mechanism with the input gear and the output gear, the speed reduction mechanism is not required to be provided in the electric motor as a separate component.

In the transfer, the first fitting portion may be a first spline provided along an axial direction of the intermediate gear, the second fitting portion may be a second spline provided along the axial direction of the electric motor, and the first spline may be fitted on the second spline. In such a configuration, the direct coupling can be facilitated only by fitting the spline of the intermediate gear and the spline of the shaft portion of the electric motor together in the axial direction.

In the transfer, the transfer may be installed in a vehicle of a front engine and rear wheel drive type. Such a configuration allows restriction of protrusion of a floor center tunnel portion for providing the transfer toward a vehicle room in an FR-based vehicle. Further, there is a case where the motor is provided on a front output shaft (front propeller shaft or the like) of the transfer. In such a case, a protrusion of the floor center tunnel portion of the vehicle toward a foot space side of a left front seat becomes large. In this point, in the present invention, because the electric motor is connected to the intermediate gear and the protrusion of the floor center tunnel portion toward the foot space side of the left front seat is thereby restricted, reduction in the foot space of the left front seat can be restricted. Consequently, the transfer can be arranged without wasting a room space.

As described above, the transfer in accordance with the present invention can improve the installability in a vehicle.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a view showing a schematic configuration of a drive system of a four-wheel drive vehicle in accordance with one embodiment of the present invention;

FIG. 2 is a cross-sectional view showing a transfer in accordance with the embodiment of the present invention; and

FIG. 3 is a view showing the relationship in dimensions of the transfer in accordance with the embodiment of the present invention.

### DETAILED DESCRIPTION OF EMBODIMENTS

An embodiment of the present invention will hereinafter be described with reference to drawings.

### Schematic Configuration of Four-Wheel Drive Vehicle

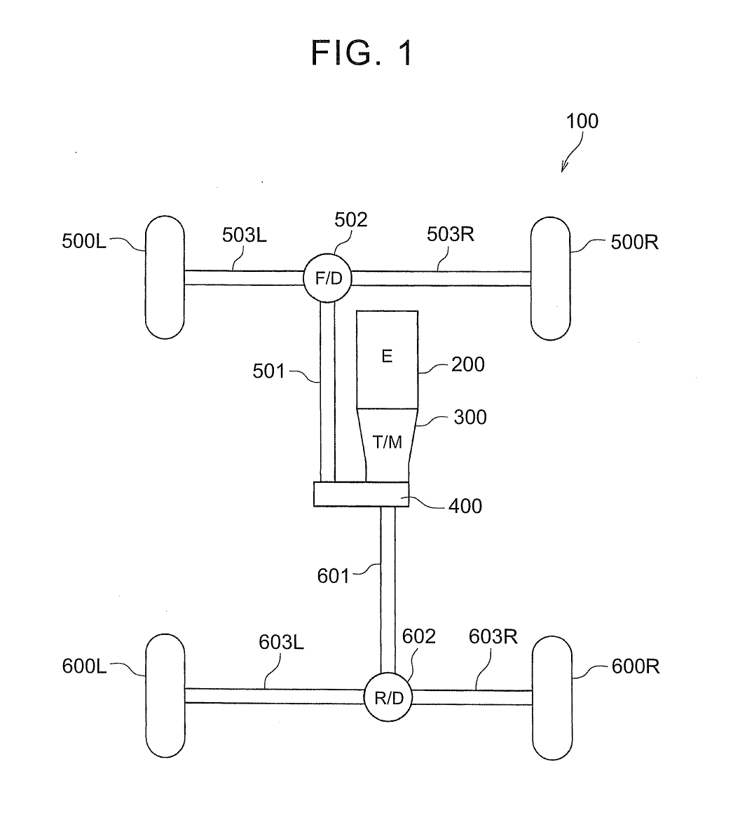

As shown in FIG. 1, a four-wheel drive vehicle 100 in accordance with this embodiment is configured to be capable of four-wheel drive travel by installing an engine (gasoline engine) 200, an automatic transmission device (T/M: automatic transmission) 300 that changes the speed of rotation output of the engine 200, and a transfer 400 arranged on a rear stage side of the automatic transmission device 300 in an FR-based vehicle of a front engine and rear wheel drive type. Further, a transmission unit is configured with the automatic transmission device 300 and the transfer 400.

The automatic transmission device 300 includes frictional engagement elements such as a plurality of clutches and brakes as a transmission mechanism. Engagement of these frictional engagement elements is controlled by hydraulic actuators such as multiple disc clutches and brakes.

Further, in the clutches and brakes, engagement and release states are switched and the transient hydraulic pressure in engagement and release and the like are controlled by excitation or non-excitation or current control of linear solenoid valves of a hydraulic pressure control device which is not shown.

As described above; the supplied hydraulic pressure to the frictional engagement elements is controlled, engagement or release of each element is thereby controlled, and predetermined gear positions and reverse position are thus set.

Driving force provided via the automatic transmission device 300 is distributed to a drive shaft 501 on a front wheel 500R (500L) side and a drive shaft 601 of a rear wheel 600R (600L) side via the transfer 400.

The drive shaft 501 on the front wheel 500R (500L) side is coupled to right and left front drive shafts 503R (503L) via a front differential (F/D) 502. The drive shaft 601 on the rear wheel 600R (600L) side is coupled to right and left rear drive shafts 603R (603L) via a rear differential (R/D) 602.

The drive shafts 503R, 503L, 603R, and 603L are coupled to the respective wheels 500R, 500L, 600R, and 600L so as to transmit power thereto. The driving force of the engine 200 is thereby distributed to the wheels 500R, 500L, 600R, and 600L, thus enabling four-wheel drive travel of the four-wheel drive vehicle 100.

### Configuration and Operation of Transfer

Next, configuration and operation of the transfer 400 will be described.

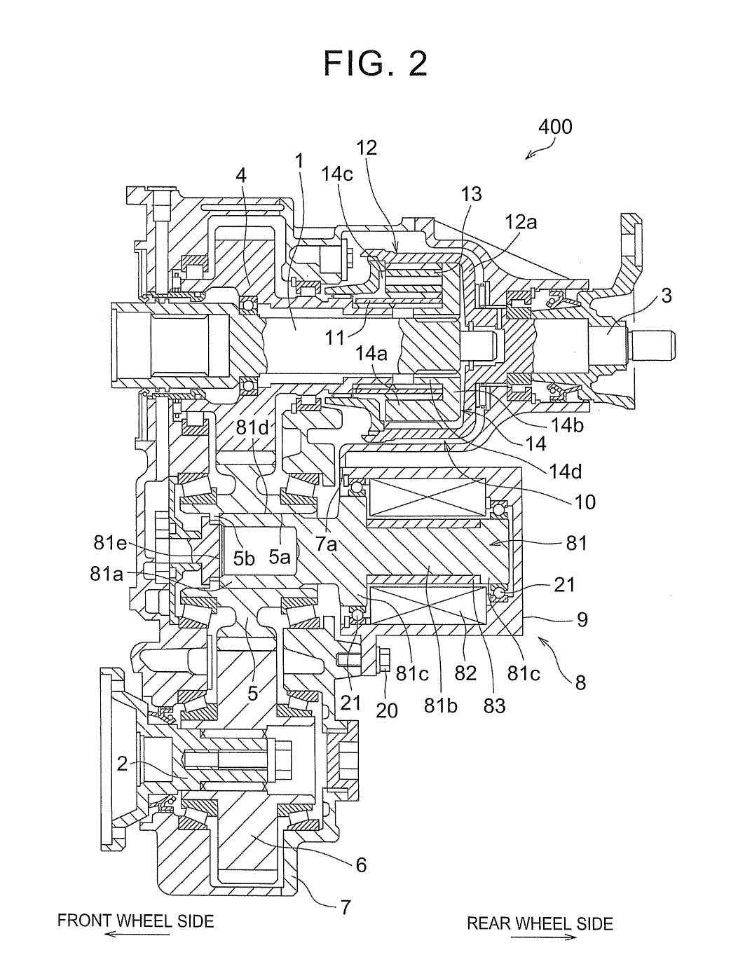

As shown in FIG. 2, the transfer 400 includes an input shaft 1, a front wheel output shaft 2, a rear wheel output shaft 3, a drive gear 4, an idler gear 5, a driven gear 6, a transfer case 7, a motor 8, a cover member 9, a planetary type differential limiting device 10 (center differential), and the like. The drive gear 4 is an example of “input gear” of the present invention, the idler gear 5 is an example of “intermediate gear”, and the driven gear 6 is an example of “output gear”.

Driving torque (driving force) generated by the engine 200 (see FIG. 1) is input to the input shaft 1. The front wheel output shaft 2 is arranged in parallel with the input shaft 1 in the transfer case 7. The rear wheel output shaft 3 is coaxially arranged with the input shaft 1 in the transfer case 7.

The drive gear 4 is mounted on an outer diameter side of the input shaft 1 via a rolling bearing so as to be capable of relative rotation and rotatably supported by the transfer case 7 via a rolling bearing. The idler gear 5 is rotatably supported by the transfer case 7 via a rolling bearing. The driven gear 6 is integrally mounted on an outer diameter side of the front wheel output shaft 2 by spline coupling and rotatably supported by the transfer case 7 via a rolling bearing.

Further, the outer teeth of the drive gear 4, the idler gear 5, and the driven gear 6 are formed as helical gears. The drive gear 4 is engaged with the idler gear 5. The idler gear 5 is engaged with the driven gear 6.

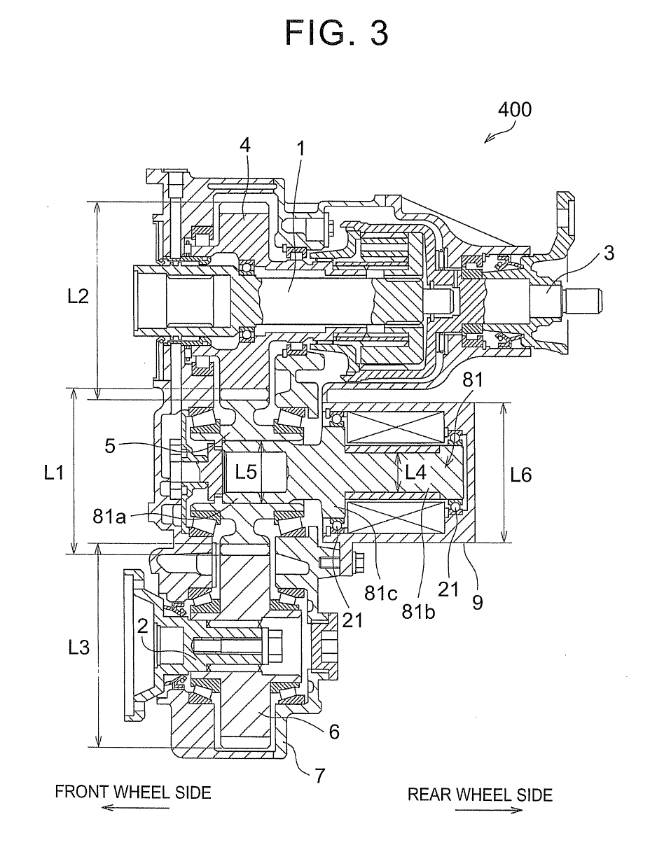

Here, as shown in FIG. 3, in this embodiment, a diameter L1 of the idler gear 5 is smaller than a diameter L2 of the drive gear 4 and a diameter L3 of the driven gear 6 that engage with the idler gear 5. The diameter L2 of the drive gear 4 is generally equal to the diameter L3 of the driven gear 6. Further, the number of teeth of the idler gear 5 is less than the numbers of teeth of the drive gear 4 and the driven gear 6 that engage with the idler gear 5. The number of teeth of the drive gear 4 is generally equal to the number of teeth of the driven gear 6. A speed reducer (reduction gear) that reduces the speed of rotation caused by the motor 8 described below and transmits the rotation is configured with the idler gear 5, the drive gear 4, and the driven gear 6.

As shown in FIG. 2, a motor mount portion 7a is formed in a portion of the transfer case 7 on the rear wheel side of the idler gear 5, and the motor 8 is mounted on the motor mount portion 7a. The motor 8 is an example of “electric motor” of the present invention. The cover member 9 is mounted on the motor mount portion 7a so as to cover the motor 8 via a gasket (not shown). Sealing is thereby made to prevent oil in the transfer case 7 from leaking to the outside. Further, the cover member 9 is fixedly fastened to the transfer case 7 by a bolt 20.

For a reference example, in this embodiment, the motor 8 is removed from the motor mount portion 7a, and a plate-like lid member or the like (not shown) is thereafter mounted on the motor mount portion 7a, thereby allowing the vehicle to have no motor (as in conventional four-wheel drive vehicles). As described above, this embodiment provides a structure in which a specification with or without a motor can very easily be selected (a structure allowing mounting of a motor after installation).

The motor 8 includes a shaft-like shaft portion 81, a coil portion 82, and a magnet 83. The shaft portion 81 has a support portion 81a arranged (fitted) in an inner peripheral portion of the idler gear 5, a magnet mount portion 81b on an outer periphery of which the magnet 83 is mounted, and two flange portions 81c formed at both ends of the magnet mount portion 81b in an axial direction.

Bearing portions 21 are arranged between outer surfaces of the flanges 81c of the shaft portion 81 and an inner surface of the cover member 9. The shaft portion 81 is thereby rotatably supported with respect to the cover member 9. Further, the coil portion 82 is arranged outside the magnet 83 at a prescribed interval. The coil portion 82 is mounted on the inner surface of the cover member 9. Motor torque generated by the motor 8 is secured (adjusted) by the length of the coil portion 82 in the axial direction (the direction in which the shaft portion 81 extends).

As shown in FIG. 3, a diameter L4 of the magnet mount portion 81b of the shaft portion 81 is formed to be smaller (narrower) than a diameter (the diameter of the inner peripheral portion of the idler gear 5) L5 of the support portion 81a. Further, the diameter L5 of the inner peripheral portion of the idler gear 5 is formed to be smaller than an outer diameter L6 of the motor 8.

As shown in FIG. 2, a spline 5a that extends along the axial direction and a protrusion portion 5b that protrudes inward from a portion on the front wheel side of the center of the idler gear 5 in the axial direction are formed in the inner peripheral portion of the idler gear 5. The spline 5a is an example of “teeth portion” of the present invention. Further, a spline 81d that extends along the axial direction is formed in an outer peripheral portion of the support portion 81a of the shaft portion 81 of the motor 8. The motor 8 is arranged to project toward the rear wheel side (outward) in the axial direction compared to a portion where the spline 5a of the idler gear 5 is formed.

The spline 5a of the inner peripheral portion of the idler gear 5 and the spline 81d of the support portion 81a of the shaft portion 81 of the motor 8 are fitted together, and a state where the motor 8 is fixed to the idler gear 5 (directly coupled state) is thereby obtained. In this state, a distal end portion 81e of the support portion 81a on the front wheel side in the shaft portion 81 is fixed to the protrusion portion 5b of the idler gear 5 in a state where the distal end portion 81e abuts against the protrusion portion 5b.

Next, a basic operation of the transfer 400 will be described.

In an FR-based fulltime four-wheel drive vehicle in accordance with this embodiment, the driving force of the front and rear wheels are fixedly distributed (for example, the front-rear distribution ratio of the driving force=40:60) by the differential limiting device 10 (center differential). In such an FR-based vehicle, the rotational speed of the motor 8 is controlled according to the traveling state or the like of the vehicle, and the front wheels are thereby accelerated or decelerated with respect to the rear wheels, thereby realizing a front-rear active torque distribution in which the torque distribution to the front and rear wheels is actively changed.

Specifically, as shown in FIG. 2, the driving force generated by the engine 200 is transmitted to the drive gear 4 and the rear wheel output shaft 3 via the input shaft 1 and the differential limiting device 10 in a normal traveling state and in a state where the motor 8 is not driven. The driving force transmitted to the drive gear 4 is transmitted to the front wheel output shaft 2 (front wheels 500R and 500L) via the idler gear 5 and the driven gear 6.

Next, in a case where the front wheels are accelerated with respect to the rear wheels, electric power according to the magnitude of acceleration is supplied to the coil portion 82 of the motor 8, and the shaft portion 81 of the motor 8 is rotationally driven. At this point, the rotation of the shaft portion 81 of the motor 8 is faster than the rotation of the idler gear 5. The rotation of the shaft portion 81 of the motor 8 is then transmitted to the idler gear 5.

The rotation of the shaft portion 81 of the motor 8 is then transmitted to the driven gear 6 and the drive gear 4. The rotation transmitted to the driven gear 6 is transmitted to the front wheel 500R (500L), thereby providing an effect of accelerating (increasing the speed of) the front wheel with respect to the rear wheels. Further, the rotation transmitted to the drive gear 4 is transmitted to the differential limiting device 10, and frictional force (differential limiting force) generated among components of the differential limiting device 10 limits the differential motion. This will be described below.

On the other hand, in a case where the front wheels are decelerated with respect to the rear wheels, the motor 8 is operated as a generator, and a regenerative brake (regenerative braking) is used, thereby decelerating the rotation of the idler gear 5. Accordingly, the rotation of the driven gear 6 engaged with the idler gear 5 is decelerated, thus decelerating the rotation of the front wheel 500R (500L). Consequently, the front wheels can be decelerated with respect to the rear wheels.

Further, the drive control of the motor 8 may be made by means of constant control by a control portion or the like (not shown) according to a previously stored map or the like or may arbitrarily be switched to a mode in which the above-described front-rear active torque distribution is performed by an operation of a predetermined switch or the like by a driver.

### Configuration and Operation of Differential Limiting Device

Next, a configuration of the differential limiting device 10 will be described.

As shown in FIG. 2, the differential limiting device 10 is a device referred to as torque sensitive “limited slip differential (LSD)”. The differential limiting device 10 has a function for outputting driving force transmitted to the input shaft 1 to the front wheel output shaft 2 and the rear wheel output shaft 3, a function for permitting differential motion between the front wheel output shaft 2 and the rear wheel output shaft 3, and a function for limiting the differential motion.

The differential limiting device 10 includes a sun gear 11, a ring gear 12, a plurality of pinion gears 13, a carrier 14, and the like. The ring gear 12 is coaxially arranged on an outer diameter side of the sun gear 11. The plurality of pinion gears 13 are arranged between the Kin gear 11 and the ring gear 12 that face each other in a radial direction. The plurality of pinion gears 13 are engaged with the sun gear 11 and the ring gear 12. Further, the plurality of pinion gears 13 are held by the carrier 14 in a state where the relative positions from each other are maintained so as to rotate and revolve.

Outer teeth of the sun gear 11 are formed as a helical gear. The sun gear 11 is integrally coupled to an outer diameter side of one end of the drive gear 4 by spline coupling and is thereby coaxially arranged with the input shaft 1. Further, the rotational power of the sun gear 11 is transmitted to the front wheel output shaft 2 via power transmission members such as the drive gear 4, the idler gear 5, and the driven gear 6.

Inner teeth of the ring gear 12 are formed as a helical gear. The rear wheel output shaft 3 is coaxially and integrally coupled to an outside center of a wall portion 12a along the radial direction of the ring gear 12, and the rotational power of the ring gear 12 is transmitted to the rear wheel output shaft 3. Further, outer teeth of the plurality of pinion gears 13 are formed as helical gears.

The carrier 14 as a whole is formed in a generally cylindrical shape with a bottom. Pockets 14c for housing and holding the pinion gears 13 via appropriate clearances are provided in several portions on a circumference of an above cylindrical portion 14a. The pocket 14c is a space passing through from the inside to the outside in the radial direction.

An inner surface (corresponding to a wall surface that forms. the pocket) of the pocket 14c is formed to recess in a partial arc shape. A boss portion 14d is provided at an inside center of a wall portion 14b of the carrier 14 along the radial direction. The input shaft 1 is fitted in an inner periphery of the boss portion 14d by spline coupling. The carrier 14 and the input shaft 1 thereby integrally rotate.

Next, a basic operation of the differential limiting device 10 will be described.

In a case where the driving force generated by the engine 200 is input to the input shaft 1 and the carrier 14 is thereby rotationally driven by the input shaft 1, the ring gear 12 and the sun gear 11 are rotationally driven via the pinion gears 13 held by the carrier 14.

For example, in a circumstance where the vehicle is traveling straight on a flat road, in normal straight traveling in which there is no rotational difference between the front wheels and the rear wheels, the ring gear 12, the pinion gears 13, and the sun gear 11 do not relatively rotate but all of those integrally rotate, and they synchronously rotate with the input shaft 1. In other words, because differential motion does not occur between the ring gear 12 and the sun gear 11, teeth tips of the pinion gears 13 hardly make slide-contact with the wall surfaces that form the pockets 14c of the carrier 14.

However, in a circumstance where the vehicle is cornering or traveling on a rough road, when a difference occurs in gripping force (rotational resistance) between the front wheels and the rear wheels, the differential limiting device 10 permits differential motion. In other words, according to the gripping force (rotational resistance) between the front wheels and the rear wheels, the pinion gears 13 held by the carrier 14 rotate and revolve; and the ring gear 12 and the sun gear 11 differentially rotate. Accordingly, torque is appropriately distributed between the front wheel output shaft 2 and the rear wheel output shaft 3. The differential rotation is limited by the frictional force generated among the components of the differential limiting device 10.

That is, when the pinion gears 13 rotate and revolve, accompanying the engagement between the teeth tips of the pinion gears 13 and the sun gear 11, the teeth tips make slide-contact with the wall surfaces of the pockets 14c of the carrier 14, thereby generating frictional force. In addition, because the ring gear 12, the sun gear 11, and the pinion gears 13 are formed of helical gears, thrust force is generated on the pinion gears 13 accompanying the engagement among those, and either end surface of each of the pinion gears 13 in the axial direction makes slide-contact with the inner surface of the wall portion 14b of the carrier 14 along the radial direction. Frictional force is thereby generated, and the frictional force thus serves as the differential limiting force.

In a circumstance where the vehicle is cornering or traveling on a rough road, in a case where a difference occurs in gripping force (rotational resistance) between the front wheels and the rear wheels, as described above, the front wheels are accelerated or decelerated with respect to the rear wheels by controlling the rotational speed of the motor 8, thereby enabling the front-rear active torque distribution in which the torque distribution to the front and rear wheels is actively changed.

As described above, the transfer 400 in accordance with this embodiment can provide effects exemplified in the following.

In this embodiment, the motor 8 is connected to the idler gear 5 as described above, and the diameter L1 of the idler gear 5 is made smaller than the diameter L2 of the drive gear 4 and the diameter L3 of the driven gear 6 that engage with the idler gear 5. Accordingly, because the diameter L1 of the idler gear 5 is smaller than the diameter L2 of the drive gear 4 and the diameter L3 of the driven gear 6 that engage with the idler gear 5, a periphery of a portion (intermediate portion) in which the idler gear 5 is arranged in the transfer 400 is made smaller in size. In addition, in this embodiment, the intermediate portion of the transfer 400 can further be made small in size compared to a case where a motor is provided (assembled), inside the idler gear 5. Accordingly, installability of the transfer 400 in the vehicle can be improved.

Further, in this embodiment, as described above, the number of teeth of the idler gear 5 is less than the numbers of teeth of the drive gear 4 that engage with the idler gear 5 and the driven gear 6 that engage with the idler gear 5. Accordingly, the speed of rotation caused by the motor 8 is reduced and transmitted to the drive gear 4 and the driven gear 6 that engage with the idler gear 5.

Further, in this embodiment, as described above, the diameter L5 of the inner peripheral portion of the idler gear 5 is formed to be smaller than the outer diameter L6 of the motor 8. Accordingly, the bearing that supports the idler gear 5 can be made small in size compared to a case where the diameter of the inner peripheral portion of the idler gear 5 is larger than the outer diameter L6 of the motor 8.

Further, in this embodiment, as described above, the spline 5a is formed in the inner peripheral portion of the idler gear 5, and the spline 81d that fits in the spline 5a of the idler gear 5 is formed in the outer peripheral portion of the support portion 81a of the motor 8. The spline 5a of the idler gear 5 and the spline 81d of the support portion 81a of the motor 8 are thereby fitted together, thus facilitating direct coupling. Moreover, because the idler gear 5 and the support portion 81a of the motor 8 are directly coupled together and thereby allowed to function as a speed reduction mechanism with the drive gear 4 and the driven gear 6, the speed reduction mechanism is not required to be provided in the motor as a separate component. In addition, the direct coupling can be facilitated only by fitting the spline 5a of the idler gear 5 and the spline 81d of the support portion 81a of the motor 8 together in the axial direction.

Further, in this embodiment, as described above, the transfer 400 is installed in an FR-based vehicle of a front engine and rear wheel drive type. This allows restriction of protrusion of a floor center tunnel portion for providing the transfer 400 in the FR-based vehicle. Further, in a conventional case, the motor 8 may be provided on the shaft of the drive shaft 501 (Fr propeller shaft). In such a case, a protrusion of the floor center tunnel portion of the vehicle toward a foot space side of a left front seat becomes large. In this point, in this embodiment, because the motor 8 is connected to the idler gear 5 and the protrusion of the floor center tunnel portion toward the foot space side of the left front seat is thereby restricted, reduction in the foot space of the left front seat can be restricted. Consequently, the transfer 400 can be arranged without wasting a room space.

### Other Embodiment

It should be understood that the embodiment disclosed in the foregoing is an exemplary case in all the aspects and does not limit the present invention. It is intended that the scope of the present invention be defined not by the embodiment discussed in the foregoing descriptions but solely by the appended claims. Further, the present invention includes all modifications within meanings equivalent to the claims and the scope thereof.

For example, in the above embodiment, the fulltime four-wheel drive vehicle in which the differential limiting device 10 (center differential) is arranged is described, but the present invention is not limited thereto. In the present invention, a two-wheel drive/four-Wheel drive switching mechanism is arranged (selected) instead of the differential limiting device 10 (center differential), and a part time four-wheel drive vehicle can thereby be provided. In the present invention, a connection state changing mechanism such as a clutch device is arranged (selected) instead of the differential limiting device 10 (center differential), and a standby four-wheel drive vehicle can thereby be provided.

Specifically, in the part time four-wheel drive vehicle, a two-wheel drive/four-wheel drive switching sleeve gear, or a dog clutch or the like that performs mechanical fastening is used as the two-wheel drive/four-wheel drive switching mechanism, the vehicle can thereby be operated as a motor-assisted four-wheel drive vehicle when the front wheels and the rear wheels are directly connected together, and the vehicle can be operated as a two-wheel drive (rear wheel drive) vehicle or an E-four-wheel drive vehicle with the motor (the rear wheels are driven by an engine, and the front wheels are driven by the motor) when the front and rear wheels are disconnected. Accordingly, a four-wheel drive system is realized in which the four-wheel drive and the E-four-wheel drive can be switched in the part time four-wheel drive vehicle.

Further, in the standby four-wheel drive vehicle, the connection state changing mechanism such as a clutch device is used, the vehicle can thereby be operated as the motor-assisted four-wheel drive vehicle when the front wheels and the rear wheels are directly connected, together (when the clutch is connected), and the vehicle can be operated as the two-wheel drive (rear wheel drive) vehicle or the E-four-wheel drive vehicle with the motor (the rear wheels are driven by an engine, and the front wheels are driven by the motor) when the front and rear wheels are disconnected (when the clutch is released). Accordingly, a four-wheel drive system is realized in which the four-wheel drive and the E-four-wheel drive can be switched in the standby four-wheel drive vehicle.

Further, in the above embodiment, an example is described where the spline is formed in the idler gear, the spline is formed in the support portion of the motor, and those are fitted together. However, the present invention is not limited thereto. In the present invention, fitting portions may be other than splines as long as a structure can directly couple the idler gear to the support portion of the motor.

The present invention can be used for a transfer, particularly for a transfer provided with an electric motor.

What is claimed is:

1. A transfer comprising:
an input gear to which driving torque is transmitted;
an intermediate gear engaging with the input gear;
an output gear engaging with the intermediate gear; and
an electric motor connected to the intermediate gear, a diameter of the intermediate gear being smaller than a diameter of the input gear and a diameter of the output gear.

2. The transfer according to claim 1,
wherein the number of teeth of the intermediate gear is less than the number of teeth of the input gear and the number of teeth of the output gear.

3. The transfer according to claim 1, wherein
the electric motor is arranged outside of the intermediate gear in an axial direction of the electric motor,
the intermediate gear has an inner peripheral portion, and
an inner diameter of the inner peripheral portion is smaller than an outer diameter of the electric motor.

4. The transfer according to claim 1, wherein
the intermediate gear has an inner peripheral portion,
a first fitting portion is provided in the inner peripheral portion, and
a second fitting portion fitting in the first fitting portion is provided in an outer peripheral portion of a shaft of the electric motor.

5. The transfer according to claim 4, wherein
the first fitting portion is a first spline provided along an axial direction of the intermediate gear,
the second fitting portion is a second spline provided along an axial direction of the electric motor, and
the first spline is fitted on the second spline.

6. The transfer according to claim 1,
wherein the transfer is installed in a vehicle of a front engine and rear wheel drive type.
